(19) United States
(12) Patent Application Publication
(10) Pub. No.: US 2020/0114828 A1
(43) Pub. Date: Apr. 16, 2020

(54) HINGED CONSOLE STORAGE COMPARTMENT

(71) Applicant: GM Global Technology Operations LLC, Detroit, MI (US)

(72) Inventors: Eric L. Beasley, Bloomfield Hills, MI (US); Lauren A. Kutskill, Warren, MI (US)

(21) Appl. No.: 16/161,589

(22) Filed: Oct. 16, 2018

(51) Int. Cl. B60R 7/04; E05D 3/12

(52) U.S. Cl. CPC B60R 7/04; E05D 3/125

(57) ABSTRACT

A console for a motor vehicle includes a console compartment formed in the console and having first, second, third, and fourth sides connected to a bottom side and enclosing a first volume, and a movable lid disposed overtop the console compartment and articulating through a first range of motion, a storage compartment including first, second, third, and fourth walls connected to a base portion and enclosing a second volume, a hinge mechanism pivotably connecting the storage compartment to the console compartment and having a hinge arm rotatably connected to the storage compartment at a first pivot and rotatably connected to the console compartment at a second pivot and allowing the storage compartment to articulate through a second range of motion from a first position to a second position.

### INTRODUCTION

The statements in this section merely provide background information relating to the present disclosure, and may not constitute prior art.

The present disclosure generally relates to motor vehicles, and more specifically to storage within center consoles of motor vehicles. Motor vehicles commonly include center consoles disposed between the front driver and passenger seats. Center consoles typically include a console compartment having pockets, holders, and slots for storing various items, such as cups, pens, coins, etc. Center consoles also often include storage compartments for storing larger items, such as compact disc jewel cases, road maps, and sunglasses. The storage compartments are covered by hinged lids that serve as armrests for the front occupants. Conventional center console designs are, however, usually substantially box-shaped and lack dividers or other similar features for organizing the contents of the storage compartment. Additionally, conventional center console designs often offer limited storage solutions beneath the armrest itself. Such limited storage solutions can manifest in disorganization within the storage compartment, and result in user or driver distraction or frustration when handling the storage compartment. Accordingly, there is a need in the art for new and improved center console storage compartment that provide a low-cost, relatively simple construction, improved organization, decreased frustration and distraction, and increased safety for users of storage space within motor vehicle center consoles.

### SUMMARY

According to several aspects of the present disclosure a console for a motor vehicle includes a console compartment formed in the console and including a first side extending towards and connected at an angle to a second side, the second side extending from the first side towards and connected at an angle to a third side, the third side extending from the second side towards and connected at an angle to a fourth side, the fourth side extending towards and connected at an angle to the first side, each of the first, second, third, and fourth sides extending from and connected at an angle to a bottom side, the first, a second, third, and fourth sides and the bottom side partially enclosing a first volume, and a movable lid disposed overtop the console compartment and articulating through a first range of motion. The console further includes a storage compartment having a first wall extending towards and connected at an angle to a second wall, the second wall extending from the first wall towards and connected at an angle to a third wall, the third wall extending from the second wall towards and connected at an angle to a fourth wall, the fourth wall extending from the third wall towards and connected at an angle to the first wall, each of the first, second, third, and fourth walls extending from and connected at an angle to a base portion, the first, second, third, and fourth walls, and the base portion partially enclosing a second volume. The console compartment further includes a hinge mechanism pivotably connecting the storage compartment to the console compartment and having a hinge arm rotatably connected to the storage compartment at a first pivot and rotatably connected to the console compartment at a second pivot, the hinge arm allowing the storage compartment to articulate through a second range of motion from a first position to a second position.

In another aspect of the present disclosure the first pivot further includes a first pivot pin rotatably connecting the hinge arm to the storage compartment and the second pivot further includes a second pivot pin rotatably connecting the hinge arm to the console compartment.

In yet another aspect of the present disclosure the first pivot and the second pivot are formed unitarily with the hinge arm, and the first pivot pin is assembled with the storage compartment via a press-fit engagement with a first receiving orifice and the second pivot pin is assembled with the console compartment via a press-fit engagement with a second receiving orifice.

In yet another aspect of the present disclosure the storage compartment further includes an outwardly extending flange.

In yet another aspect of the present disclosure the outwardly extending flange of the storage compartment supports the storage compartment on an upper limit of the console compartment when the storage compartment is in the first position.

In yet another aspect of the present disclosure the console compartment further includes a shelf portion.

In yet another aspect of the present disclosure the base portion of the storage compartment is supported on the shelf portion when the storage compartment is in the second position.

In yet another aspect of the present disclosure when the movable lid is in an open position, the hinge mechanism is free to articulate through the second range of motion between the first position and the second position, and when the movable lid is in a closed position, the hinge mechanism is prevented from articulating through the second range of motion.

In yet another aspect of the present disclosure the storage compartment is disposed entirely outside of the first volume when the storage compartment is in the second position.

In yet another aspect of the present disclosure when the storage compartment is in the second position, the hinge arm is disposed in a recess in at least one of the at least one of the front, passenger, rear, and driver sides of the console compartment, and the compartment lid is free to articulate through the first range of motion.

In yet another aspect of the present disclosure the console further includes a pad, the pad is disposed at a predetermined location on the console and reduces noise, vibration, and harshness characteristics of the console.

In yet another aspect of the present disclosure a console for a motor vehicle includes a console compartment formed in the console and including a first side extending towards and connected at an angle to a second side, the second side extending from the first side towards and connected at an angle to a third side, the third side extending from the second side towards and connected at an angle to a fourth side, the fourth side extending towards and connected at an angle to the first side, each of the first, second, third, and fourth sides extending from and connected at an angle to a bottom side, the first, a second, third, and fourth sides and the bottom side partially enclosing a first volume, a movable lid is disposed overtop the console compartment and articulates through a first range of motion from a closed position to an open position. The console further includes a storage compartment having a first wall extending towards and connected at an angle to a second wall, the second wall extending from the first wall towards and connected at an angle to a third wall, the third wall extending from the second wall towards and connected at an angle to a fourth wall, the fourth wall extending from the third wall towards and connected at an angle to the first wall, each of the first, second, third, and fourth walls extending from and connected at an angle to a base portion, the first, second, third, and fourth walls, and the base portion partially enclosing a second volume. The console further includes a hinge mechanism pivotably connecting the storage compartment to the console compartment and including a hinge arm rotatably connected to the storage compartment at a first pivot and rotatably connected to the console compartment at a second pivot, the hinge arm allowing the storage compartment to articulate through a second range of motion from a first position to a second position. The console further includes a pad, the pad is disposed at a predetermined location on the console and reduces noise, vibration, and harshness characteristics of the console.

In yet another aspect of the present disclosure the first pivot further includes a first pivot pin rotatably connecting the hinge arm to the storage compartment and the second pivot further includes a second pivot pin rotatably connecting the hinge arm to the console compartment.

In yet another aspect of the present disclosure the first pivot pin and the second pivot pin are formed unitarily with the hinge arm, and the first pivot pin is assembled with the storage compartment via a press-fit engagement with a first receiving orifice and the second pivot pin is assembled with the console compartment via a press-fit engagement with a second receiving orifice.

In yet another aspect of the present disclosure the first pivot pin is formed unitarily with the storage compartment and the second pivot pin is formed unitarily with the console compartment, and the first pivot pin and the second pivot pin are assembled with the hinge arm via a press-fit engagement.

In yet another aspect of the present disclosure the storage compartment further includes an outwardly extending flange supporting the storage compartment on an upper limit of the console compartment when the storage compartment is in the first position.

In yet another aspect of the present disclosure the console compartment further includes a shelf portion, the base portion of the storage compartment is supported on the shelf portion when the storage compartment is in the second position.

In yet another aspect of the present disclosure when the movable lid is in an open position, the hinge mechanism is free to articulate through the second range of motion between the first position and the second position, and when the movable lid is in a closed position, the hinge mechanism is prevented from articulating through the second range of motion.

In yet another aspect of the present disclosure the storage compartment is disposed entirely outside of the first volume when the storage compartment is in the second position, and when the storage compartment is in the second position, the hinge arm is disposed in a recess in at least one of the at least one of the front, passenger, rear, and driver sides of the console compartment, and the compartment lid is free to articulate through the first range of motion.

In yet another aspect of the present disclosure a console for a motor vehicle includes a console compartment formed in the console and includes: a plurality of sides connected at an angle to a bottom side, the plurality of sides and the bottom side partially enclosing a first volume, a movable lid is disposed overtop the console compartment fully enclosing the first volume, the movable lid articulating through a first range of motion from a closed position to an open position. The console for a motor vehicle further includes a storage compartment selectively disposed within the first volume and including a plurality of walls connected at an angle to a base portion, the plurality of walls and the base portion partially enclosing a second volume; and an outwardly extending flange. The console further includes a hinge mechanism pivotably connecting the storage compartment to the console compartment and includes: a hinge arm rotatably connected to the storage compartment at a first pivot and rotatably connected to the console compartment at a second pivot, the hinge arm allowing the storage compartment to articulate through a second range of motion from a first position to a second position, the first pivot includes a first pivot pin rotatably connecting the hinge arm to the storage compartment and the second pivot includes a second pivot pin rotatably connecting the hinge arm to the console compartment. The console further includes a pad, the pad is disposed at a predetermined location on the console and reduces noise, vibration, and harshness characteristics of the console. When the movable lid is in an open position the hinge mechanism is free to articulate through the second range of motion between the first position and the second position, when the movable lid is in a closed position the hinge mechanism is prevented from articulating through the second range of motion, and the outwardly extending flange supports the storage compartment on an upper limit of the console compartment when the compartment is in the first position.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an environmental view of a motor vehicle equipped with a hinged console storage compartment according to an aspect of the present disclosure;

FIG. 2 is a partial perspective view of a motor vehicle center console having a hinged console storage compartment according to an aspect of the present disclosure;

FIG. 3; is a partial perspective view of a motor vehicle center console having a hinged console storage compartment in a first position according to an aspect of the present disclosure;

FIG. 4 is a partial perspective view of a motor vehicle center console having a hinged console storage compartment between the first position and a second position according to an aspect of the present disclosure; and

FIG. 5 is a partial perspective view of a motor vehicle center console having a hinged console storage compartment in a second position according to an aspect of the present disclosure.

### DETAILED DESCRIPTION

Reference will now be made in detail to several embodiments of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity, directional terms such as top, bottom, left, right, up, over, above, below, beneath, rear, and front, may be used with respect to the drawings. Likewise, the terms “forward”, “rear”, “inner”, “inwardly”, “outer”, “outwardly”, “above”, and “below” are terms used relative to the orientation of the motor vehicle as shown in the drawings of the present application. Thus, “forward” refers to a direction toward a front of a motor vehicle, “rearward” refers to a direction toward a rear of a motor vehicle, “passenger” refers to a direction towards a passenger side of the motor vehicle (right-hand side in the context of this particular application), “driver” or “driver side” refers to a direction towards the driver's side of the motor vehicle (right-hand side in the context of this particular application), “inner” and “inwardly” refers to a direction towards the interior of a motor vehicle, and “outer” and “outwardly” refers to a direction towards the exterior of a motor vehicle, “below” refers to a direction towards the bottom of the motor vehicle, and “above” refers to a direction towards a top of the motor vehicle. These and similar directional terms are not to be construed to limit the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises”, “includes,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “disposed on,” “connected to,” or “coupled to” another element or layer, it may be directly on, engaged, disposed, connected or coupled to the other element or layer, or intervening elements or layers may be present. In contrast, when an element is referred to as being “directly on,” “directly engaged to,” “directly disposed on,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The term “vehicle” as described herein can be construed broadly to include not only a passenger automobile, but any other vehicle including, but not limited to, rail systems, planes, off-road sport vehicles, robotic vehicles, motorcycles, trucks, sport utility vehicles (SUVs), recreational vehicles (RVs), marine vessels, aircraft, farming vehicles, construction vehicles, and the like.

The following description is merely exemplary in nature and is not intended to limit the present disclosure, application, or uses.

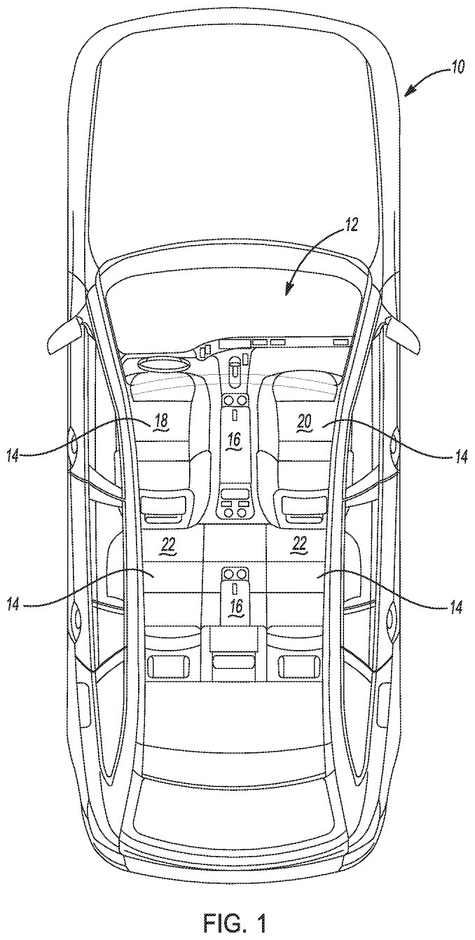

Referring now to FIG. 1, a motor vehicle is shown and generally indicated by reference number 10. While the motor vehicle 10 illustrated is a car, it should be appreciated that the motor vehicle 10 may be any type of vehicle, including a car, a van, a truck, a motor home, rail vehicle such as a train a tram, or the like, or any other such vehicle without departing from the scope or intent of the present disclosure. The motor vehicle 10 includes a passenger compartment 12 having a plurality of seats 14. A center console 16 is disposed between a driver seat 18 and a passenger seat 20. While the center console 16 has been described as being between the driver seat 18 and the passenger seat 20 additional center consoles 16 may be placed elsewhere throughout the passenger compartment 12. For example, an additional center console 16 may be disposed between the rear seats 22 of the passenger compartment 12 without departing from the scope or intent of the present disclosure. The center console 16 serves several functions. In some aspects, the center console 16 provides a driver, a passenger, or rear seat passengers, or all of the above, a resting place for an arm. In other aspects, the center console 16 defines a console compartment 22.

The console compartment 22 has a front side 24 extending towards and connected at an angle to a passenger side 26. The passenger side 26 extends towards and is connected at an angle to a rear side 28. The rear side 28 extends towards and is connected at an angle to a driver side 30, and the driver side 30 extends towards and is connected at an angle to the front side 24. The console compartment 22 also has a bottom side 32. The bottom side 32 is connected at an angle to each of the front, passenger, rear, and driver sides 24, 26, 28, 30. The front, passenger, rear, and driver sides 24, 26, 28, 30, and the bottom side 32 define a first volume “V1” within the center console 16. A movable compartment lid 34 covers the console compartment 22. In several aspects, the compartment lid 34 has a substantially planar underside 36 and a padded top 38. The padded top 38 provides a soft and forgiving surface on which it is comfortable for an occupant of the motor vehicle 10 to rest an arm or other extremity. The lid 34 may take any of a variety of forms without departing from the scope or intent of the present disclosure. In some aspects, the lid 34 is rotatably connected to the center console 16 at a hinge 40. In other aspects, the lid 34 is slidably connected to the center console 16 along a racetrack (not specifically shown). In still further examples, the lid 34 may both slidably and rotatably connected to the center console 16. The hinge 40 of some examples may also be located at other locations around the center console 16 without departing from the scope or intent of the present disclosure. In one example, the hinge 40 is located along the front side 26 of the console compartment providing a front-hinged console lid 34. In another example, the hinge 40 is located along the passenger or driver side 28, 32 of the center console 16 thereby providing a side-hinged lid 34.

The hinge 40 of some examples is selectively engageable. That is, in some examples, a center console 16 of the present disclosure includes a plurality of hinges 42 disposed at various locations around the center console 16 and connecting the lid 34 to the center console 16. The hinges 42 may each be actuated separately when used with a monolithic lid 34. When one of the plurality of hinges 40 is actuated, the others of the plurality of hinges 40 are de-coupled from either the lid 34 or the center console 16, thereby allowing free movement of the lid 34 relative to the console compartment 24 about the axis of rotation for the actuated hinge. Once the lid 34 is closed, the others of the plurality of hinges 40 are re-coupled with either the lid 34 or the center console 16.

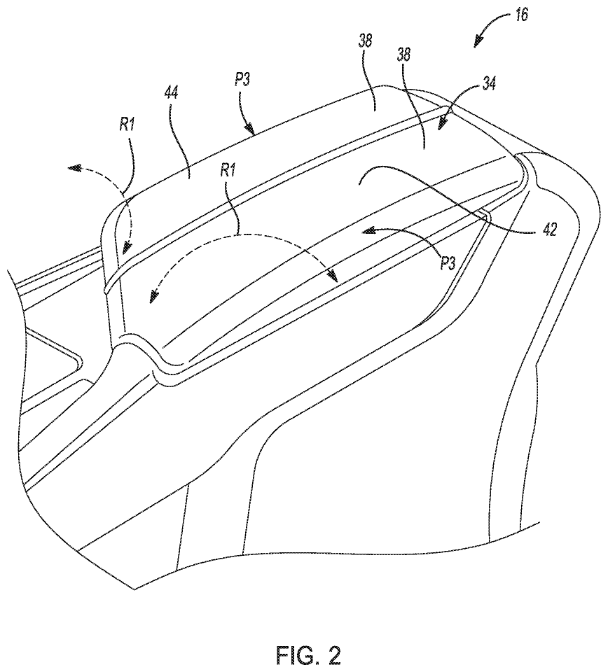

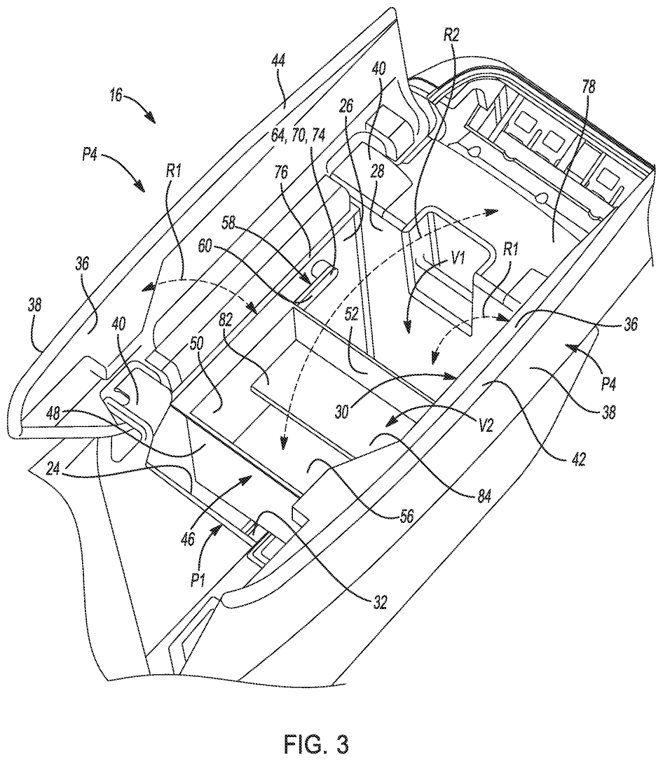

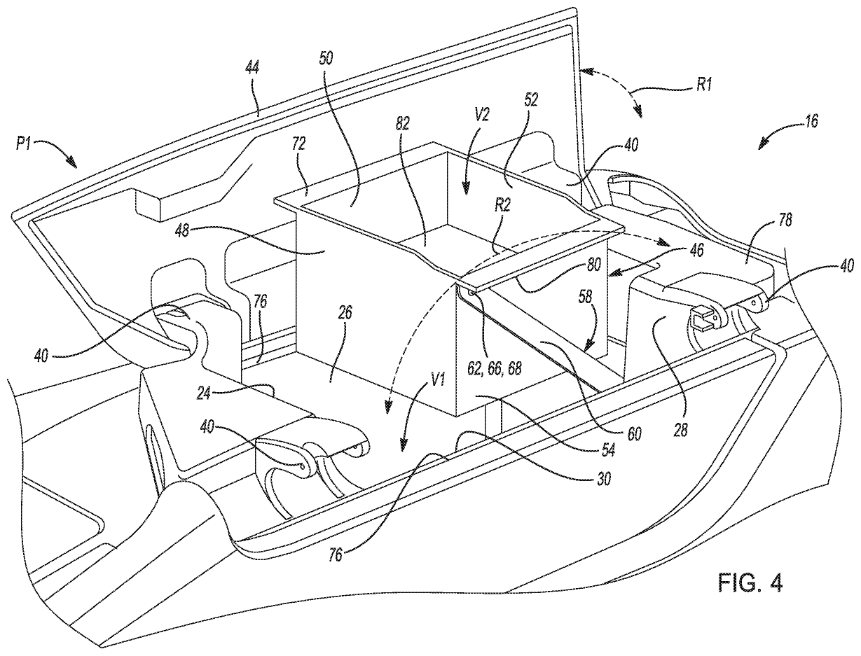

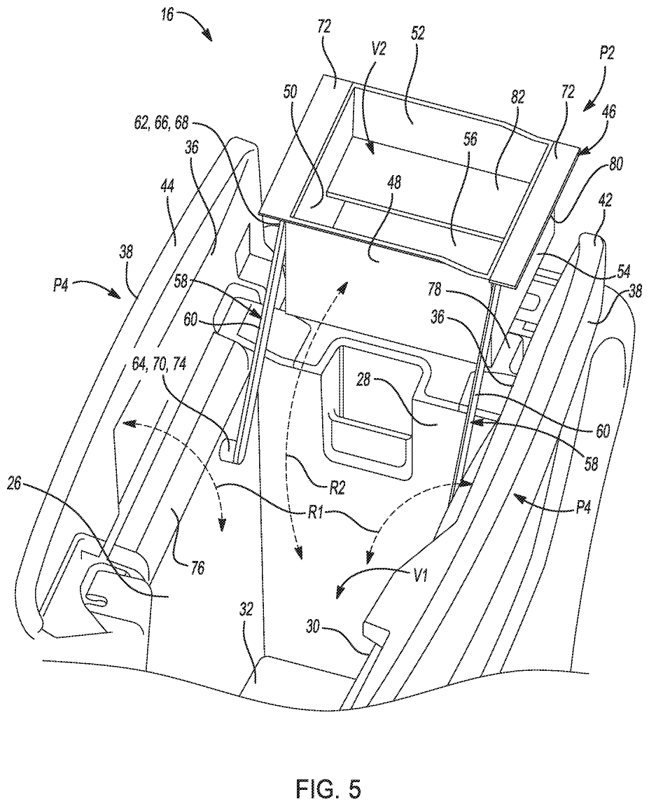

Additionally, the lid 34 may be monolithic or, as is shown in FIGS. 2-5, the lid 34 may have a plurality of movable components. That is, in some examples, the lid 34 operates as a single rotatable or slidable piece in relation to the center console 16 itself, while in other examples, the lid 34 may have multiple selectively independently movable sections such as a first panel or driver side panel 42 and a second panel or passenger side panel 44, each of which is independently movable relative to the center console 16 and/or to each other. In one example the first panel 42 is in hinged connection with the center console 16 substantially proximate to and parallel with the driver side 30 of the center console 16. The second panel 44 is in hinged connection with the center console 16 substantially proximate to and parallel with the passenger side 26 of the center console 16. In another example not specifically shown in the figures, the lid 34 has a first panel 42 in hinged connection with the center console 16 substantially proximate to and parallel with the front side 24 of the center console 16 and a second panel 44 in hinged connection with the center console 16 substantially proximate to and parallel with the rear side 28 of the center console 16. While in the foregoing description, the console compartment 22 has been described as having four (front, passenger, rear, driver 24, 26, 28, 30) sides, a bottom side 32, and a lid 34, it should be appreciated that the console compartment 22 is defined by the vehicle platform. Accordingly, the console compartment 22 may have more or fewer than four sides, and the bottom side 32 may have a substantially non-planar surface. Additionally, the lid 34 has been described as having either a monolithic or a two-part structure, however it should be appreciated that the lid 34 may take other forms and have a structure that has more than two selectively independently movable component parts.

Dimensions of the console compartment 22 vary in accordance with space constraints within the passenger compartment 12 of the motor vehicle 10. Thus, in a relatively large motor vehicle 10 such as a full-sized pickup truck the center console 16, and therefore, the console compartment 22 each have dimension substantially larger than an equivalent center console 16 and console compartment 22 in a relatively small vehicle such as a sub-compact motor vehicle 10.

Turning now to FIGS. 2-5, and with continuing reference to FIG. 1, the console compartment 22 is equipped with a storage compartment 46. The storage compartment 46 is shaped and sized to fit within the console compartment 22 of the motor vehicle 10. The storage compartment 46 can be constructed in any of a variety of different manners and from a variety of different materials in accordance with the production specifications and production volume requirements of the application. That is, in some aspects, the storage compartment 46 is constructed of a plastic material, a vinyl material, a metal material, or any other such material that meets predetermined structural characteristics and/or production specification and/or production volume requirements inherent to the application. In some aspects, the storage compartment 46 is formed by rapid prototyping processes such as 3-D printing, directed light fabrication, direct-shell production casting, ballistic particle manufacturing, selected laser sintering, or the like. In other aspects, the storage compartment 46 is formed by injection molding, rotational (roto) molding, extrusion blow molding, injection blow molding, vacuum casting, thermoforming, compression molding, or the like.

The storage compartment 46 has a plurality of side walls including at least a first or front wall 48 substantially parallel to the front side 24 of the console compartment 22. The front wall 48 extends towards and is connected at an angle to a second or passenger wall 50. The passenger wall 50 runs substantially parallel to the passenger side 26 of the storage compartment. The passenger wall 50 extends from the front wall 48 to a third or rear wall 52 to which the passenger wall 50 is connected at an angle. The rear wall 52 runs substantially parallel to the rear side 28 of the console compartment 22. The rear wall 52 extends from the passenger wall 46 to a fourth or driver wall 54. The driver wall 54 runs substantially parallel to the driver side 30 of the console compartment 22. The driver wall 50 extends from the rear wall 52 to the front wall 48. The front wall 48 is connected at an angle to the driver wall 50. Each of the front, passenger, rear, and driver walls 48, 50, 52, 54 are connected at an angle to a base portion 56. The front, passenger, rear, and driver walls 48, 50, 52, 54 and the base portion 56 define a second volume “V2”, smaller than the first volume “V1”. In several aspects, the base portion 56 forms a substantially planar bottom portion of each of the storage compartment 46. The base portion and the front, passenger, rear, and driver walls 48, 50, 52, 54 and the base portion 56 are sized and shaped to fit concentrically within the console compartment 22. More specifically, the base portion 56 is shaped and contoured to fit within the architecture of the console compartment 22 of a given vehicle application. Moreover, each of the storage compartment 46 is shaped and sized to maximize utility, including maximizing storage capacity of the console compartment 22 and of the storage compartment 46. In several aspects, as a means of maximizing storage capacity, each of the front, passenger, rear, and driver walls 48, 50, 52, 54 is angled slightly so that a top portion 56 of each is outside the footprint of the base portion 56. That is, at the top portion 56 each of the storage compartment 46 is wider than at locations proximate the base portion 56. Put another way, the front, passenger, rear, and driver walls 48, 50, 52, 54 flare outwardly from the footprint of the base portion 56 as they extend upward from the base portion 56.

In several aspects, the storage compartment 46 is movable from at least a first position “P1” to a second position “P2”. To effectuate the movement from the first position “P1” to the second position “P2”, the storage compartment 46 is connected to a hinge mechanism 58. The hinge mechanism 58 is composed of a hinge arm 60 connected to the storage compartment 46 at a first pivot 62 and extending to a second pivot 64. The hinge arm 60 is connected to the console compartment 22 or, more generally, to the center console 16 at the second pivot 64. In several aspects, the first and second pivots 62, 64 have substantially cylindrical shapes. An axis of each of the substantially cylindrical first and second pivots 62, 64 is orthogonal to the substantially planar front, passenger, rear, and/or driver sides 24, 26, 28, 30 of the console compartment 22 and/or the front, passenger, rear, and/or driver walls 48, 50, 52, 54 of the storage compartment 46 to which each of the first and second pivots 62, 64 is attached. Between the first and second pivots 62, 64, the hinge arm 60 has a center section 65 that has a flattened rectangular prism shape having a substantially uniform thickness (not specifically shown). However, it should be appreciated that the center section 65 of the hinge arm 60 may have an ovoid, circular, triangular, quadrilateral, pentagonal, or other like cross-sectional shape without departing from the scope or intent of the present disclosure. The hinge arm 60 center section 65 is shaped to provide sufficient structural strength, rigidity, and resiliency to the hinge mechanism 58 while at least partially fitting between the storage compartment 46 console compartment 22 and not impeding movement of the storage compartment 46 and/or the lid 34.

The hinge arm 60 is composed of plastic material, a vinyl material, a metal material, or any other such material that meets predetermined structural characteristics and/or production specification and/or production volume requirements inherent to the application. In some aspects, hinge arm 60 is formed by rapid prototyping processes such as 3-D printing, directed light fabrication, direct-shell production casting, ballistic particle manufacturing, selected laser sintering, or the like. In other aspects, the hinge arm 60 is formed by injection molding, rotational (roto) molding, extrusion blow molding, injection blow molding, vacuum casting, thermoforming, compression molding, or the like.

The first pivot 62 is composed of a first pivot pin 66 extending into a socket 68 in the hinge arm 60. The second pivot 64 Is composed of a second pivot pin 70 extending into a second socket 74 in the hinge arm 60. In several aspects, the first pivot pin 66 is unitarily formed with and extends outwardly from the storage compartment 46 and the second pivot pin 70 is unitarily formed with and extends outwardly from the console compartment 22. In other aspects, the first pivot pin 66 is a separate and distinct component press-fit inserted into a first receiving orifice (not specifically shown) in the storage compartment 46 and the second pivot pin 70 is a separate and distinct component press-fit inserted into a second receiving orifice (not specifically shown) in the console compartment 22. In still further aspects, the first and second pivot pins 66, 70 are unitarily formed with the hinge arm 60 and form a press-fit connection when inserted into the first and second receiving orifices in the storage compartment 46 and the console compartment 22 respectively. In one example, the first and second pivot pins 66, 70 are formed of a plastic material having predetermined physical qualities, such as a predetermined strength, coefficient of friction, and vibration reduction qualities. The plastic material of the first and second pivot pins 66, 70 may be a nylon, a Polytetrafluoroethylene (PTFE), or like materials without departing from the scope or intent of the present disclosure. In some examples, the first and second pivot pins 66, 70 may even be constructed of a metallic material, depending on the design constraints for a particular application. While the first and second pivot pins 66, 70 have been described as being unitarily formed with either the storage compartment 46 and storage compartment 66, or with the hinge arm 60, or separate and distinct from each of the aforementioned components, it should be appreciated that variations or combinations of the constructions for the first and second pivot pins 66, 70 are intended to be within the scope or intent of the present disclosure.

In some examples a single hinge arm 60 is used to provide a means of articulation for the storage compartment 46 from the first position “P1” to the second position “P2”. In other examples a plurality of hinge arms 60 are used to provide a means of articulation and control movement of the storage compartment 46 from the first position “P1” to the second position “P2.” That is, while the figures show a storage compartment 46 in pivoting connection with two hinge arms 60, it should be appreciated that fewer than two, or more than two hinge arms 60 may be used with the storage compartment 46 without departing from the scope or intent of the present disclosure.

In several aspects, depending on the architecture of the console compartment 22, at least one of the front, passenger, rear, and driver walls 48, 50, 52, 54 further includes an outwardly extending flange 72. The outwardly extending flange 72 extends outwardly from the storage compartment 46 and towards and beyond at least one of the front, passenger, rear, and driver sides 24, 26, 28, 30 of the console compartment 22. The outwardly extending flange 72 provides a support on which the storage compartment 46 rests on an upper limit 76 of the front, passenger, rear, and/or driver sides 24, 26, 28, 30 of the console compartment 22 in the first position “P1”. The outwardly extending flange 72 of the figures has a substantially rectangular shape, however it should be appreciated that the outwardly extending flange 72 need not have a rectangular shape in order to support the storage compartment 46 on the upper limit 76 of the at least one of the front, passenger, rear, and driver sides 24, 26, 28, 30 of the console compartment. That is, the outwardly extending flange 72 may take any of a variety of different shapes including but not limited to: substantially rectangular, ovoid, circular, triangular, or other such shapes. In some aspects, the outwardly extending flange 72 may be better described as a peg or plurality of pegs (not specifically shown) extending outward from the storage compartment 46 and supporting the storage compartment 46 on the upper limit 76 of the console compartment 22 in the first position “P1”.

Each of the front, passenger, rear, and driver walls 48, 50, 52, 54 and the base portion 56 have a thickness (not specifically shown) and each of the front, passenger, rear, and driver walls 48, 50, 52, 54 have a wall height (not specifically shown). In several aspects, depending on the method of production, the thickness may vary between the front, passenger, rear, and driver walls 48, 50, 52, 54 and the base portion 56. In other aspects, some manufacturing methods produce front, passenger, rear, and driver walls 48, 50, 52, 54 and base portion 56 having substantially identical thicknesses. In some examples, depending on the architecture of the console compartment 22, at least one of the front, passenger, rear, and driver walls 48, 50, 52, 54 has a wall height lower than at least one of the other walls. By providing at least one of the front, passenger, rear, and driver walls 48, 50, 52, 54 with a lower height than the other walls around it, a user of the console compartment 22 may effectively route electrical devices such as cellphone power cables, auxiliary input/output cables, USB cables or the like from a given storage compartment 46 to a power source such as a 12V lighter socket or the like. In some examples, rather than, or in addition to providing at least one of the front, passenger, rear, and driver walls 48, 50, 52, 54 with a decreased height relative to the other walls, at least one of the front, passenger, rear, and driver walls 48, 50, 52, 54 is formed with a passageway (not specifically shown). The passageway is sized and shaped to allow a cellphone charging cable, auxiliary input/output cables, USB cables, or the like, to pass from within the confines of a given storage compartment 46 into the first volume “V1” defined by the console compartment 22 itself. Moreover, in some aspects, at least one of the front, passenger, rear, and driver walls 48, 50, 52, 54 is provided with a lip (not specifically shown). Depending on the application, the lip extends either inwardly, outwardly, or both, and provides a user the ability to more easily grab or gain additional purchase of the given storage compartment 46 with a hand.

The console compartment 22 further includes a shelf portion 78. In several aspects, the shelf portion 78 is disposed proximate to the rear side 28 of the console compartment 22 and extends rearward, in relation to the volume “V1” of the console compartment 22. Referring once more to the compartment lid 34, the compartment lid 34 can articulate through a first range of motion “R1” from a closed position “P3” to an open position “P4.” When the compartment lid 34 is in the closed position “P3”, the occupants of the motor vehicle 10 can support arms, hands, or the like, as well as objects on the padded top 38 of the compartment lid 34. When the compartment lid 34 is in the open position “P4”, occupants of the motor vehicle 10 can access the first and second volumes “V1”, “V2” of the console compartment 22 and storage compartment 46 respectively.

In some examples, when the compartment lid 34 is in a closed position “P3”, the console compartment 22, the storage compartment 46, and the shelf portion 78 are hidden from view beneath the compartment lid 34. By contrast, in when the compartment lid 34 is in an open position “P4”, the console compartment 22, the storage compartment 46, and the shelf portion 78 are exposed. Furthermore, when the compartment lid 34 is in the open position “P4”, the hinge mechanism 58 allows the storage compartment 46 to articulate from the first position “P1” to the second position “P2.” In the second position “P2” the base portion 56 of the storage compartment 46 rests on and is supported by the shelf portion 78 of the console compartment 22. Moreover, when the storage compartment 46 is in the second position “P2” the entire interior volume “V1” of the console compartment 22 is accessible to a user of the console compartment 22. By utilizing the hinge mechanism 58 to limit and movement of the storage compartment 46, and by providing the storage compartment 46 with an outwardly extending flange 72 to support the storage compartment 46 in the first position “P1” and a shelf portion 78 to support the storage compartment 46 in the second position “P2”, a user of the console compartment 22 does not have to find a place to store the storage compartment 46 while accessing the rest of the console compartment 22. That is, the user is not tasked with removing the storage compartment 46 entirely from the console compartment 22, balancing the storage compartment 46 in some precarious position such as placing the storage compartment 46 on the floor, in a lap, or on a seat or other surface within the passenger compartment 12 of the motor vehicle 10. Instead, the hinge mechanism 58 in conjunction with the outwardly extending flange 72 and the shelf portion 78 allow limited and stabilized movement of the storage compartment 46 while also providing user access to the console compartment 22.

As has been shown and described, when the storage compartment 46 is in the second position “P2”, the storage compartment 46 has articulated from the first position “P1” rearward so that the storage compartment 46 is supported on the shelf portion 78. However, depending on spatial considerations, ergonomic constraints, and the like, the shelf portion 78 may in some examples be disposed proximate the front side 24 of the console compartment 22, or on the passenger side 26, or on the driver side 30. In some examples, the console compartment 22 may be equipped with a plurality of shelf portions 78 providing the storage compartment 46 a plurality of second positions “P2”. That is, in accordance with the location of the shelf portion 78 relative to the console compartment 22, the hinge mechanism 58 is oriented to provide the storage compartment 46 with a second position “P2” that is outside of the interior volume “V1” of the console compartment 22 and in which the storage compartment 46 rests on the shelf portion 78.

In a first example, the hinge mechanism 58 is disposed towards the front side 24 of the console compartment 22 and provides the storage compartment 46 with a second range of motion “R2” allowing the storage compartment 46 to move from a first position “P1” resting substantially within the interior volume “V1” of the console compartment 22 as described hereinabove, to a second position “P2” in which the storage compartment 46 rests on a shelf portion 78 disposed proximate the front side 24 of the console compartment 22. In an extension of the first example, in some aspects, the shelf portion 78 is disposed entirely outside the volume “V1” of the console compartment 22 and is instead a portion of the center console 16 not covered by the compartment lid 34 at all. In other words, in the first example, when the storage compartment 46 is in the second position “P2” the storage compartment 46 is entirely outside the console compartment 22. Moreover, in the first example the hinge mechanism 58 is connected to the console compartment 22 and the storage compartment 46 in a manner that does not interfere with hinged and/or sliding movement of the compartment lid 34. More specifically, in some aspects, when the storage compartment 46 is in the second position “P2”, the hinge arms 60 are sandwiched between the compartment lid 34 and the console compartment 22 in a manner that does not interfere with movement of the compartment lid 34 from an open to a closed position. Furthermore, in some aspects, in the second position “P2”, the hinge arms 60 are disposed in slots or recesses (not shown) formed at least one of the at least one of the front, passenger, rear, and driver sides 24, 26, 28, 30 of the console compartment 22, thereby preventing the hinge arms 60 from interfering with movement of the compartment lid 34 while allowing the storage compartment 46 to remain outside the volume “V1” of the console compartment 22 when the compartment lid 34 is either open or closed.

In a second example, the hinge mechanism 58 is disposed towards the passenger side 26 and/or the driver side 30 of the console compartment 22 and provides the storage compartment 46 with the second range of motion “R2” allowing the storage compartment 46 to move from a first position “P2” resting substantially within the interior volume “V1” of the console compartment 22 as described hereinabove, to a second position “P2” in which the storage compartment 46 rests on a shelf portion 78 disposed proximate the passenger side 26 and/or the driver side 30 of the console compartment 22. Moreover, the hinge mechanism 58 is connected to the console compartment 22 and the storage compartment 46 in a manner that does not interfere with hinged and/or sliding movement of the compartment lid 34. More specifically, in some aspects, when the storage compartment 46 is in the second position “P2”, the hinge arms 60 are sandwiched between the compartment lid 34 and the console compartment 22 in a manner that does not interfere with movement of the compartment lid 34 from an open to a closed position. Furthermore, in some aspects, in the second position “P2”, the hinge arms 60 are disposed in slots or recesses (not shown) formed in the console compartment 22, thereby preventing the hinge arms 60 from interfering with movement of the compartment lid 34 while allowing the storage compartment 46 to remain outside the volume “V1” of the console compartment 22 when the compartment lid 34 is either open or closed.

In several aspects, the storage compartment 46 has a foot portion or pad (not specifically shown). The foot portions or pads of some examples are disposed predetermined locations about the console compartment 22, the storage compartment 46, and/or the hinge mechanism 58 to reduce potential noise vibration and harshness (NVH) characteristics of the center console 16. In one aspect, the foot portions or pads are disposed at intersections of each of the front, passenger, rear, and driver walls 46, 48, 50, and 52. The foot portion or pad is formed integrally as a part of the base portion 56 as well as with the front, passenger, rear, and driver walls 48, 50, 52, 54 of the storage compartment 46. In some examples, the foot portions or pads are substantially circular protrusions extending from the base portion 56, while in other examples the foot portions or pads are substantially rectilinear protrusions extending from the base portion 56. In other aspects, the foot portions or pads are made of a pliable or resilient material, such as a foam material, a rubberized plastic material, a silicone material, a rubber material, or other such cushioning and noise isolating materials and adhered to the base portion 56 with an adhesive. In some examples, the foot portions or pads are disposed along at least a portion of the base portion 56 along at least one of the front, passenger, rear, and driver walls 48, 50, 52, 54. By locating the foot portions or pads along the base portion 56 along at least one of the front, passenger, rear, and driver walls 48, 50, 52, 54, the foot pads 62 are optimally placed to support the storage compartment 46 on the shelf portion 78 while also insulating and damping vibration between the shelf portion 78 and the storage compartment 46 when the storage compartment 46 is in the second position “P2”. In further aspects, foot portions or pads are disposed on an underside 80 of the outwardly extending flange 72, thereby providing insulation and damping vibration between the outwardly extending flange 72 and the front, passenger, rear, and/or driver sides 24, 26, 28, 30 of the console compartment 22 when the storage compartment 46 is in the first position “P1”. While in the foregoing description the foot portions or pads have been described as being formed integrally with or attached with adhesive to the base portion 56 and the outwardly extending flange 72, it should be appreciated that the foot portions or pads may also be attached to the shelf portion 78 and/or the upper limit 76 of the front, passenger, rear, and/or driver sides 24, 26, 28, 30 of the console compartment 22 without departing from the scope or intent of the present disclosure. Moreover, in some examples, the foot portions or pads are also disposed on a contact surface (not specifically shown) of the hinge arms 60 or on a contact surface (not specifically shown) of the upper limit 76 of the front, passenger, rear, and/or driver sides 24, 26, 28, 30 of the console compartment 22. By placing the foot portions or pads on the contact surface of the hinge arms 60 or the contact surface of the of the upper limit 76 of the front, passenger, rear, and/or driver sides 24, 26, 28, 30 of the storage compartment, NVH effects are decreased. That is, when the storage compartment 46 is in the second position “P2” and the contact surface of the hinge arms 60 is in contact with the contact surface of the upper limit 76 of the front, passenger, rear, and/or driver sides 24, 26, 28, 30 of the storage compartment, rattling and/or vibration of the hinge arms 60 against the console compartment 22 is reduced by use of the foot portions or pads.

In some examples, the storage compartment 46 is provided with a divider 82. The divider 82 serves to create divided sub-compartments within the storage compartment 46, thereby increasing the utility and organizational capabilities of the storage compartment 46 and of the console compartment 22 more broadly. In several aspects, the divider 82 may be unitarily formed with the storage compartment 46, or the divider 82 may be formed as a separate and distinct component that is assembled with the storage compartment 46. In some examples, a plurality of dividers 82 may be disposed in or formed with the storage compartment 46 without departing from the scope or intent of the present disclosure. In further examples, a divider 82 or dividers 82 may also be formed in or assembled with the console compartment 22 and be entirely separate from the storage compartment 46 and any dividers 82 within the storage compartment 46.

While the foregoing description and drawings focus primarily on center consoles 16 having a storage compartment 46 that articulates up and rearward out of the first volume “V1” of the console compartment 22, it should be appreciated that depending on the location of the hinge 40 for the console lid 34, and depending on ergonomic, packaging, and other such constraints, the storage compartment 46 may instead articulate forward, towards either the driver or passenger side of the passenger compartment 12, or in any combination of the above mentioned directions without departing from the scope or intent of the present disclosure.

A console compartment 22 having a hinged storage compartment 46 of the present disclosure offers several advantages, these include providing the user or operator of the center console compartment 22 the ability to neatly and efficiently organize belongings within the console compartment 22, while increasing the utility of the storage compartment 46 within the console compartment 22 and improving safety by reducing the potential for user frustration and/or distraction while using or accessing the contents of the storage compartment 46. Moreover, because the storage compartment 46 of some examples can be articulated to a second position “P2” that is entirely outside the console compartment 22, the space within the console compartment 22 is optimized, while improving the utility of the console lid 34 and the storage compartment 22 itself. Additionally, the storage compartment 46 of the present disclosure has a low-cost, relatively simple construction, and can be retrofitted to some existing motor vehicles 10.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A console for a motor vehicle comprising:
a console compartment formed in the console and comprising:
a first side extending towards and connected at an angle to a second side, the second side extending from the first side towards and connected at an angle to a third side, the third side extending from the second side towards and connected at an angle to a fourth side, the fourth side extending towards and connected at an angle to the first side, each of the first, second, third, and fourth sides extending from and connected at an angle to a bottom side, the first, a second, third, and fourth sides and the bottom side partially enclosing a first volume, and a movable lid disposed overtop the console compartment and articulating through a first range of motion;
a storage compartment comprising:
a first wall extending towards and connected at an angle to a second wall, the second wall extending from the first wall towards and connected at an angle to a third wall, the third wall extending from the second wall towards and connected at an angle to a fourth wall, the fourth wall extending from the third wall towards and connected at an angle to the first wall, each of the first, second, third, and fourth walls extending from and connected at an angle to a base portion, the first, second, third, and fourth walls, and the base portion partially enclosing a second volume;
a hinge mechanism pivotably connecting the storage compartment to the console compartment and comprising:
a hinge arm rotatably connected to the storage compartment at a first pivot and rotatably connected to the console compartment at a second pivot, the hinge arm allowing the storage compartment to articulate through a second range of motion from a first position to a second position.

2. The console of claim 1 wherein first pivot further comprises a first pivot pin rotatably connecting the hinge arm to the storage compartment and the second pivot further comprises a second pivot pin rotatably connecting the hinge arm to the console compartment.

3. The console of claim 2 wherein the first pivot and the second pivot are formed unitarily with the hinge arm, and wherein the first pivot pin is assembled with the storage compartment via a press-fit engagement with a first receiving orifice and the second pivot pin is assembled with the console compartment via a press-fit engagement with a second receiving orifice.

4. The console of claim 1 wherein the storage compartment further comprises an outwardly extending flange.

5. The console of claim 4 wherein the outwardly extending flange of the storage compartment supports the storage compartment on an upper limit of the console compartment when the storage compartment is in the first position.

6. The console of claim 1 wherein the console compartment further comprises a shelf portion.

7. The console of claim 6 wherein the base portion of the storage compartment is supported on the shelf portion when the storage compartment is in the second position.

8. The console of claim 1 wherein when the movable lid is in an open position, the hinge mechanism is free to articulate through the second range of motion between the first position and the second position, and wherein when the movable lid is in a closed position, the hinge mechanism is prevented from articulating through the second range of motion.

9. The console of claim 1 wherein the storage compartment is disposed entirely outside of the first volume when the storage compartment is in the second position.

10. The console of claim 9 wherein when the storage compartment is in the second position, the hinge arm is disposed in a recess in at least one of the at least one of the front, passenger, rear, and driver sides of the console compartment, and the compartment lid is free to articulate through the first range of motion.

11. The console of claim 1 further comprising a pad, wherein the pad is disposed at a predetermined location on the console and reduces noise, vibration, and harshness characteristics of the console.

12. A console for a motor vehicle comprising:
a console compartment formed in the console and comprising:
a first side extending towards and connected at an angle to a second side, the second side extending from the first side towards and connected at an angle to a third side, the third side extending from the second side towards and connected at an angle to a fourth side, the fourth side extending towards and connected at an angle to the first side, each of the first, second, third, and fourth sides extending from and connected at an angle to a bottom side,
the first, a second, third, and fourth sides and the bottom side partially enclosing a first volume, a movable lid is disposed overtop the console compartment and articulates through a first range of motion from a closed position to an open position;
a storage compartment comprising:
a first wall extending towards and connected at an angle to a second wall, the second wall extending from the first wall towards and connected at an angle to a third wall, the third wall extending from the second wall towards and connected at an angle to a fourth wall, the fourth wall extending from the third wall towards and connected at an angle to the first wall, each of the first, second, third, and fourth walls extending from and connected at an angle to a base portion, the first,
second, third, and fourth walls, and the base portion partially enclosing a second volume;
a hinge mechanism pivotably connecting the storage compartment to
the console compartment and comprising:
a hinge arm rotatably connected to the storage compartment at a first pivot and rotatably connected to the console compartment at a second pivot, the hinge arm allowing the storage compartment to articulate through a second range of motion from a first position to a second position; and
a pad, wherein the pad is disposed at a predetermined location on the console and reduces noise, vibration, and harshness characteristics of the console.

13. The console of claim 12 wherein first pivot further comprises a first pivot pin rotatably connecting the hinge arm to the storage compartment and the second pivot further comprises a second pivot pin rotatably connecting the hinge arm to the console compartment.

14. The console of claim 13 wherein the first pivot pin and the second pivot pin are formed unitarily with the hinge arm, and wherein the first pivot pin is assembled with the storage compartment via a press-fit engagement with a first receiving orifice and the second pivot pin is assembled with the console compartment via a press-fit engagement with a second receiving orifice.

15. The console of claim 13 wherein the first pivot pin is formed unitarily with the storage compartment and the second pivot pin is formed unitarily with the console compartment, and wherein the first pivot pin and the second pivot pin are assembled with the hinge arm via a press-fit engagement.

16. The console of claim 12 wherein the storage compartment further comprises an outwardly extending flange supporting the storage compartment on an upper limit of the console compartment when the storage compartment is in the first position.

17. The console of claim 12 wherein the console compartment further comprises a shelf portion, wherein the base portion of the storage compartment is supported on the shelf portion when the storage compartment is in the second position.

18. The console of claim 12 wherein when the movable lid is in an open position, the hinge mechanism is free to articulate through the second range of motion between the first position and the second position, and wherein when the movable lid is in a closed position, the hinge mechanism is prevented from articulating through the second range of motion.

19. The console of claim 12 wherein the storage compartment is disposed entirely outside of the first volume when the storage compartment is in the second position, and wherein when the storage compartment is in the second position, the hinge arm is disposed in a recess in at least one of the at least one of the front, passenger, rear, and driver sides of the console compartment, and the compartment lid is free to articulate through the first range of motion.

20. A console for a motor vehicle comprising:
a console compartment formed in the console and comprising: a plurality of sides connected at an angle to a bottom side, the plurality of sides and the bottom side partially enclosing a first volume, a movable lid is disposed overtop the console compartment fully enclosing the first volume, the movable lid articulating through a first range of motion from a closed position to an open position;
a storage compartment selectively disposed within the first volume and comprising: a plurality of walls connected at an angle to a base portion, the plurality of walls and the base portion partially enclosing a second volume; and an outwardly extending flange;
a hinge mechanism pivotably connecting the storage compartment to the console compartment and comprising: a hinge arm rotatably connected to the storage compartment at a first pivot and rotatably connected to the console compartment at a second pivot, the hinge arm allowing the storage compartment to articulate through a second range of motion from a first position to a second position, the first pivot comprising a first pivot pin rotatably connecting the hinge arm to the storage compartment and the second pivot comprising a second pivot pin rotatably connecting the hinge arm to the console compartment; and
a pad, wherein the pad is disposed at a predetermined location on the console and reduces noise, vibration, and harshness characteristics of the console,
wherein when the movable lid is in an open position the hinge mechanism is free to articulate through the second range of motion between the first position and the second position, when the movable lid is in a closed position the hinge mechanism is prevented from articulating through the second range of motion, and the outwardly extending flange supports the storage compartment on an upper limit of the console compartment when the compartment is in the first position.
